(19) United States
(12) Patent Application Publication
(10) Pub. No.: US 2010/0320635 A1
(43) Pub. Date: Dec. 23, 2010

(54) METHOD FOR PRODUCING POLYMER MEMBER HAVING PLATED FILM

(75) Inventors: Hironori OTA, Osaka (JP); Atsushi Yusa, Osaka (JP); Tetsuya Ano, Osaka (JP)

Correspondence Address: BIRCH STEWART KOLASCH & BIRCH, PO BOX 747, FALLS CHURCH, VA, 22040-0747, US

(73) Assignee: Hitachi Maxell, Ltd, Ibaraki-shi (JP)

(21) Appl. No.: 12/816,958

(22) Filed: Jun. 16, 2010

(30) Foreign Application Priority Data
Jun. 17, 2009 (JP) 2009-143939

(51) Int. Cl. B29C 45/16; B05D 3/10

(52) U.S. Cl. 264/129; 427/304

(57) ABSTRACT

To provide a method for producing a polymer member having a plated film with excellent adhesion by subjecting a polymer member in which a catalyst component is dispersed by using pressurized carbon dioxide to electroless plating under ordinary pressure. A polymer member in which a catalyst component is dispersed is formed by using a pressurized fluid in which a catalyst component containing a metal which serves as a plating catalyst is dissolved in pressurized carbon dioxide; the polymer member in which the catalyst component is dispersed is immersed in an alcohol treatment liquid under ordinary pressure; and the polymer member, which has been subjected to the pretreatment with the alcohol treatment liquid, is immersed in an electroless plating solution containing an alcohol under ordinary pressure to form a plated film.

### BACKGROUND OF THE INVENTION

1. Field of the Invention

The present invention relates to a method for producing a polymer member having a plated film formed by electroless plating.

2. Description of the Related Art

An electroless plating method has conventionally been known as a method for forming a metal film on a surface of a polymer member. Since the electroless plating method is a method in which a metal film is formed on an article to be plated by reducing metal ions utilizing a catalytic chemical reaction, it is necessary to adhere a metal substance having catalytic activity stably and uniformly to the inner surface of the article to be plated to secure the adhesion of the plated film finally obtained, excluding cases where an article to be plated itself has catalytic activity against a reduction action of a reducing agent. When the article to be plated is a polymer member such as a resin molded article, therefore, the surface of the polymer member is roughened by an etching treatment using an etching solution containing an oxidant with high environmental burden such as hexavalent chromic acid or permanganic acid prior to electroless plating to form concavities and convexities on the surface of the resin molded article, and then a metal substance which serves as a catalytic nucleus is supplied to the concavities and convexities. The polymer member to be immersed in the etching solution, in other words, the polymer member to which the electroless plating is applicable, is limited to a polymer member containing an ABS resin. This is because the ABS resin contains a butadiene rubber component which is selectively corroded with the etching solution, whereas other resins contain few components which are selectively corroded with the etching solution and it is difficult to form concavities and convexities on the surface of the resin molded article. Therefore, when polymer members containing a resin component other than the ABS resin, such as a polycarbonate resin, are subjected to electroless plating, plating-grade products containing an ABS resin or elastomer are used in order to allow the electroless plating. When such a plating-grade product is used, however, deterioration of physical properties such as heat resistance of main materials cannot be avoided.

In order to solve the problems described above, there has been proposed a method for forming a polymer member in which a catalyst component such as a metal complex containing a metal serving as a plating catalyst is dispersed, by using a pressurized fluid such as supercritical carbon dioxide, prior to electroless plating. For example, proposed is a method wherein a resin molded article is brought into contact with a pressurized fluid in which a catalyst component is dissolved in supercritical carbon dioxide, thereby obtaining a polymer member in which the catalyst component is dispersed; or a method wherein a molten resin is brought into contact with a pressurized fluid in which a catalyst component is dissolved in supercritical carbon dioxide within a cylinder, and the resulting molten resin is injection-molded, thereby obtaining a polymer member in which the catalyst component is dispersed (Japanese Patent No. 3696878). As the supercritical fluid has both permeability as a gas and solvent properties as a liquid and the catalyst component dissolved in the pressurized fluid permeates into a resin molded article or a molten resin with the permeation of the pressurized fluid, by using the pressurized fluid in which the catalyst component as described above is dissolved, the polymer member in which the catalyst component is dispersed can be formed without the etching treatment. According to the method as described above, therefore, it is not necessary to use an oxidant with high environmental burden such as hexavalent chromic acid and a plated film can be formed even on a polymer member having few components which are corroded with an etching solution by electroless plating.

However, when a polymer member obtained by the method using a pressurized fluid is subjected to electroless plating under ordinary pressure, the formed plated film has a problem of low adhesion. That is, according to the conventional method in which the electroless plating is performed after the etching treatment, a plating catalyst is supplied to the polymer member whose surface is etched to have concavities and convexities, and metal particles develop by utilizing the plating catalyst present in the concavities and convexities as a catalyst nucleus. Accordingly, in the inside of the polymer member, there is a state where the plated film is embedded in the concavities and convexities at the interface between the plated film and the polymer member, thereby obtaining the adhesion of the plated film. On the other hand, the pressurized fluid permeates into the polymer member but does not corrode the polymer member unlike the etching treatment, and because the pressurized fluid penetrates not only into the surface of the polymer member but also into the deep inside thereof, the concentration of the plating catalyst decreases near the surface where a good anchor effect can be obtained. In particular, when the catalyst component is dispersed in a molten resin using an injection-molding method as disclosed in Japanese Patent No. 3696878, the concentration of the plating catalyst present near the surface of the polymer member decreases because the specific gravity of the catalyst component containing the metal is higher than that of the resin component. In order to increase the amount of the plating catalyst present near the surface of the polymer member when dispersing the catalyst component in the polymer member using a pressurized fluid, therefore, it is necessary to use a pressurized fluid in which the catalyst component such as the metal complex, which serves as the plating catalyst, is dissolved as high a concentration as possible. However, because it is difficult to permeate the electroless plating solution into the inside of the polymer member when the electroless plating is performed under ordinary pressure, even if a pressurized fluid in which a catalyst component is dissolved at a high concentration is used, the plated film develops from the plating catalysts present on the outermost surface of the polymer member. As a result, even if the density of the plated film formed on the outermost surface of the polymer member is increased, the plated film is not formed in the state where it enters into the resin in the inside of the polymer member and therefore, a good anchor effect cannot be obtained.

The present applicants have previously proposed, therefore, a method in which a polymer member in which a catalyst component is dispersed by using a pressurized fluid obtained by dissolving the catalyst component in pressurized carbon dioxide is formed and then the polymer member is subjected to electroless plating using an electroless plating solution containing pressurized carbon dioxide and an alcohol, thereby developing a plated film from the inside of the polymer member (Japanese Patent No. 4092364). Although it is difficult to compatibilize the electroless plating solution containing water as its main component with pressurized carbon dioxide, when an alcohol is contained in the electroless plating solution, high-pressure carbon dioxide can be dissolved in the electroless plating solution without stirring. As a result, the plating component permeates into the inside of the polymer member together with pressurized carbon dioxide and the alcohol by immersing the polymer member in which the catalyst component is dispersed at a high concentration in the electroless plating solution, whereby the plated film can be developed utilizing the plating catalyst dispersed in the inside of the polymer member as the catalyst nucleus.

However, even when the electroless plating solution containing pressurized carbon dioxide and an alcohol as described above is used, the plated film is likely to develop from the outermost surface of the polymer member treated using a pressurized fluid containing the catalyst component at a high concentration, because a large amount of the plating catalyst exists on the outermost surface of the polymer member. As a result, problems are caused, such as generation of weak adhesion parts on the plated film and easy occurrence of variation in adhesion among electroless plating treatments. In addition, the production burden of the method is high, since, for example, a production apparatus with high accuracy of sealing is required, because high pressure is necessary in order to permeate the electroless plating solution containing pressurized carbon dioxide into the catalyst component present in the deep inside of the polymer member. For this reason, the utilization rate of the plating catalyst dispersed in a polymer member is still low in view of industrial production. As a result, when the dispersing treatment of dispersing the catalyst component by using a pressurized fluid and the electroless plating treatment disclosed in Japanese Patent No. 4092364 are combined, there is a problem of high cost. In addition, in a case where the catalyst component is dispersed in a molten resin by injection-molding as disclosed in Japanese Patent No. 3696878, when a pressurized fluid in which the catalyst component is dissolved in the saturation concentration thereof, the catalyst component easily deposits from the pressurized fluid before it permeates into the polymer member due to pressure change in a cylinder. The deposited catalyst component cannot permeate into the inside of the polymer member because it is not dissolved in the pressurized fluid and becomes unnecessary. In addition, the concentration of the plating catalyst dispersed in the polymer member decrease due to the deposition of the catalyst component and the catalyst component is nonuniformly dispersed in the polymer member, thus resulting in a decrease of the adhesion of the plated film and large variation in the adhesion. The deposition of the catalyst component as described above can be decreased by decreasing the concentration of the catalyst component to be dissolved in the pressurized fluid, but in this case, the adhesion of the plated film further decreases disadvantageously, because the amount of the catalyst component introduced into the polymer member decreases.

Also, according to the electroless plating using pressurized carbon dioxide disclosed in Japanese Patent No. 4092364, it is necessary to place the electroless plating solution and the polymer member which is an article to be plated in a hermetic container which can withstand use under high-temperature and high-pressure environments, because the electroless plating solution containing pressurized carbon dioxide and an alcohol is used. For this reason, the electroless plating is necessarily performed in a batch manner because the number of the polymer members which can be treated at a time is restricted depending on the volume of the hermetic container. As a result, the method of electroless plating using pressurized carbon dioxide as disclosed in Japanese Patent No. 4092364 is not suitable for continuous production processes, and high mass-production capability is hardly expected therefrom. Accordingly, after forming a polymer member in which a catalyst component is dispersed by using a pressurized fluid, it is desired to perform the electroless plating under ordinary pressure. However, as described above, there is a problem that, when the electroless plating is performed under ordinary pressure, the plated film develops utilizing the plating catalyst present on the outermost surface of the polymer member as a catalyst nucleus and therefore a plated film having high adhesion cannot be formed because the electroless plating solution cannot permeate enough into the inside of the polymer member.

The present invention is a method capable of solving the problems described above and an object of the invention is to provide a production method capable of producing a polymer member having a plated film with excellent adhesion by subjecting a polymer member in which a catalyst component is dispersed by using pressurized carbon dioxide to electroless plating under ordinary pressure.

### SUMMARY OF THE INVENTION

The present invention relates to a method for producing a polymer member having a plated film, including:

a dispersing step of forming, using a pressurized fluid in which a catalyst component containing a metal which serves as a plating catalyst is dissolved in pressurized carbon dioxide, a polymer member in which the catalyst component is dispersed;

a pretreatment step of immersing the polymer member in which the catalyst component is dispersed in an alcohol treatment liquid under ordinary pressure; and

an electroless plating step of immersing the polymer member subjected to the pretreatment with the alcohol treatment liquid in an electroless plating solution containing an alcohol under ordinary pressure to form a plated film.

In an aspect in which the catalyst component is dispersed in the resin molded article in the production method described above, the dispersing step may include forming a polymer member in which the catalyst component is dispersed by bringing the pressurized fluid into contact with a resin molded article. In this aspect, the resin molded article may be used in the form of a sheet. In this aspect, the production method may further include an insert molding step of placing the sheet-like polymer member in which the catalyst component is dispersed in a mold and injecting a molten resin into the mold to integrate the sheet-like polymer member with the molten resin, after the dispersing step and before the pretreatment step.

In an aspect in which the catalyst component is dispersed in a molten resin in the production method described above, the dispersing step may include forming the polymer member in which the catalyst component is dispersed by bringing the pressurized fluid into contact with a molten resin and injection-molding or extrusion-molding the molten resin in which the catalyst component is dispersed. In this aspect, the dispersing step may also include forming the polymer member in which the catalyst component is dispersed by bringing the pressurized fluid into contact with a first molten resin, injecting the first molten resin in which the catalyst component is dispersed into a mold, and injecting a second molten resin containing no catalyst component into the mold containing the first molten resin in which the catalyst component is dispersed. In the aspect described above, the pressurized fluid may further contain a fluorine organic solvent.

According to the production method of the present invention, a polymer member having a plated film with excellent adhesion can be produced by subjecting a polymer member in which a catalyst component is dispersed by using a pressurized fluid to a pretreatment with an alcohol treatment liquid under ordinary pressure and subjecting the polymer member which has been subjected to the pretreatment to electroless plating by using an electroless plating solution containing an alcohol under ordinary pressure. Also, according to the production method described above, a plated film with high adhesion can be formed even on a polymer member having a small amount of a catalyst component. In addition, according to the production method described above, it is not necessary to perform electroless plating using pressurized carbon dioxide because both the pretreatment with the alcohol treatment liquid and the electroless plating can be performed under ordinary pressure. Accordingly, it is not necessary to use a highly pressure resistant production apparatus which imposes high burden in production in the electroless plating, and a polymer member having a plated film with excellent adhesion can be continuously produced in industrial production.

### BRIEF DESCRIPTION OF THE DRAWINGS

FIG. 1 is a schematic cross-sectional view showing a production apparatus used in a dispersing step in Example 1 of the present invention;

FIG. 2 is a schematic view showing a production apparatus used in a dispersing step in Example 2 of the present invention;

FIG. 3 is a schematic view showing a wound body used in a dispersing step in Example 2 of the present invention; and

FIGS. 4A and 4B are schematic cross-sectional views of a main part showing states of an insert molding step in Example 2 of the present invention, wherein FIG. 4A is a schematic cross-sectional view of the main part showing a state where a sheet-like polymer member is placed in a mold, and FIG. 4B is a schematic cross-sectional view of the main part showing a state where a molten resin is filled into a mold by injection.

### DETAILED DESCRIPTION OF THE INVENTION

The method for producing a polymer member having a plated film of an embodiment of the present invention will be specifically described in the following.

The method for producing a polymer member having a plated film of this embodiment includes a dispersing step of forming a polymer member in which a catalyst component is dispersed by using a pressurized fluid in which a catalyst component containing a metal which serves as a plating catalyst is dissolved in pressurized carbon dioxide. By using the pressurized fluid in which the catalyst component containing the metal which serves as the plating catalyst is dissolved in pressurized carbon dioxide, the catalyst component can be dispersed in the polymer member without performing etching using an etching solution containing hexavalent chromic acid or the like with high environmental burden. Also, by using pressurized carbon dioxide, it is possible to permeate the catalyst component into the inside of the polymer member and accordingly, a plated film can be formed on a polymer member made of a resin having no etching component by electroless plating to be described later.

The catalyst component is not particularly limited as long as it has solubility in pressurized carbon dioxide in the dispersing step and contains a metal which serves as a plating catalyst in the electroless plating step. Specifically, fine particles containing a metal such as palladium, platinum, nickel, copper or silver, complexes containing these metals, and modified products such as oxides of metal complexes are exemplified. Of these, metal complexes having high solubility in pressurized carbon dioxide are preferable. Examples of the catalyst component include bis(cyclopentadienyl)nickel, bis(acetylacetonato)palladium (II), dimethyl(cyclooctadienyl)platinum (II), hexafluoroacetyl acetonatopalladium (II), hexafluoroacetyl acetonatohydratecopper (II), hexafluoroacetyl acetonatoplatinum (II), hexafluoroacetyl acetonato(trimethylphosphine)silver (I), dimethyl(heptafluorooctanedionate)silver (AgFOD), and modified products thereof such as oxides thereof. They may be used alone or as a mixture of two or more of them. Of these, metal complexes having fluorine as a ligand are preferable, because they have high solubility in pressurized carbon dioxide. After being dispersed in the polymer member, the metal complex may be sometimes reduced due to heat in the production apparatus and dispersed in the polymer member as an elemental metal. By such reduction, the metal substance which serves as a plating catalyst upon electroless plating can be immobilized in the inside of the polymer member. The catalyst component, accordingly, may be dispersed in the polymer member in the state where the component is modified into an elemental metal prior to the electroless plating step.

Pressurized carbon dioxide may be used in the state of a liquid or a gas, or in a supercritical state. The higher the pressure is, the higher the solubility of the catalyst component in pressurized carbon dioxide becomes. Thus, in the conventional electroless plating in which it is necessary to disperse a large amount of a catalyst component in the polymer member, carbon dioxide is used in a supercritical state. According to the production method of this embodiment, however, even if the polymer member in which the catalyst component is dispersed at a low concentration is used as an article to be plated, a plated film having excellent adhesion can be formed, and thus pressurized carbon dioxide which is not in a supercritical state can be used. As pressurized carbon dioxide, accordingly, either carbon dioxide which is pressurized to a critical point (a supercritical state at a temperature of 31° C. or more and a pressure of 7.38 MPa or more) or more may be used, or carbon dioxide which is pressured with a pressure lower than the critical point may be used. More specifically, pressurized carbon dioxide preferably has a pressure of 5 to 30 MPa and a temperature of 10 to 150° C. When the pressure is lower than 5 MPa, the density of pressurized carbon dioxide tends to decrease. On the other hand, when the pressure is higher than 30 MPa, a highly pressure resistant system is required as the production apparatus, which leads to high cost. When the temperature is lower than 10° C., the dispersibility of the catalyst component tends to deteriorate. On the other hand, when the temperature is higher than 150° C., sealing of the production apparatus tends to be difficult. Pressurized carbon dioxide preferably has a density of 0.10 to 0.99 g/cm³.

When the pressurized fluid in which the catalyst component is dissolved in pressurized carbon dioxide is prepared, a conventionally known method may be used. For example, the pressurized fluid can be prepared by pressurizing liquid carbon dioxide through a pressurizing means such as a pump, supplying pressurized carbon dioxide to a dissolution bath to which the catalyst component has been added, and mixing the catalyst component with pressurized carbon dioxide. The concentration of the catalyst component in the pressurized fluid may be the saturation concentration thereof, but in the production method of this embodiment, when the concentration of the catalyst component is low, for example, a concentration lower than the saturation concentration, good effects can be obtained. For this reason, the amount of the catalyst component introduced, which does not contribute to the plating reaction, can be decreased. Also, because the concentration of the catalyst component in the pressurized fluid is low, even if a change in pressure occurs when the catalyst component is dispersed in the molten resin by an injection-molding method or extrusion-molding method, the deposition of the catalyst component can be reduced. According to the production method of this embodiment, therefore, economic efficiency can be improved and a polymer member in which a catalyst component is uniformly dispersed can be obtained. Further, when the concentration of the catalyst component in the pressurized fluid is low, the amount of the catalyst component adhered to the outermost surface of the polymer member decreases. Consequently, formation of a plated film having a poor anchor effect on the outermost surface can be prevented.

In this embodiment, when the molten resin prior to molding is brought into contact with the pressurized fluid by utilizing the injection-molding method or extrusion-molding method, the pressurized fluid may further contain a fluorine organic solvent. The catalyst component can be efficiently dispersed near the surface of the polymer member by using the fluorine organic solvent in the dispersing step. Also, because the fluorine organic solvent has high heat resistance, decomposition of the catalyst component can be prevented by using the pressurized fluid containing the fluorine organic solvent when contacting and kneading is performed at a high temperature. As a result, when the catalyst component such as a metal complex is exposed to heat in the production apparatus before the pressurized fluid is brought into contact with the molten resin, heat-reduction into an elemental metal can be prevented and the catalyst component can be more efficiently dispersed in the polymer member. Further, as described above, in the preparation of the pressurized fluid, pressurized carbon dioxide is supplied to the dissolution bath to which the catalyst component has been added and the components are mixed and stirred under a high pressure and therefore, when the pressurized fluid is newly prepared, it is necessary to reduce the pressure in the supply pathway once and then to supply the catalyst component to the dissolution bath. On the contrary, when the fluorine organic solvent is used, a mixed solution in which the catalyst component is dissolved in the fluorine organic solvent can be prepared under ordinary pressure and the pressurized fluid can be prepared by pressurizing the mixed solution and mixing the resulting solution with pressurized carbon dioxide in the pipe. As a result, it is not necessary to use a high-pressure dissolution bath for mixing the catalyst component with pressurized carbon dioxide and it is also not necessary to reduce the pressure in the dissolution bath in order to dissolve the new catalyst component in pressurized carbon dioxide. When the fluorine organic solvent is used as described above, it is preferable to mix the catalyst component and the fluorine organic solvent to prepare a mixed solution, pressurizing the resulting mixed solution, and mixing the pressurized mixed solution and pressurized carbon dioxide to prepare the pressurized fluid.

The fluorine organic solvent is not particularly limited, and examples thereof include perfluoroalkylamines, perfluoroalkyl polyether carboxylic acids, perfluoroalkanes, and fluorine surfactants. These may be used alone or as a mixture of two or more of them. Of these, perfluoroalkylamines which are inexpensive, and have excellent solubility in pressurized carbon dioxide and high heat resistance (desirably having a boiling point of 150° C. or more), such as perfluorotripropylamine, perfluorotributylamine and perfluorotripentylamine are more preferable. When using the fluorine organic solvent, the concentration of the catalyst component in the mixed solution depends on the kinds of the catalyst component and the fluorine organic solvent used and is not particularly limited. However, the concentration is preferably from 0.01 to 10% by mass.

A resin material forming the polymer member in which the catalyst component is dispersed may be arbitrarily selected, and thermoplastic resins, thermosetting resins and ultraviolet curable resins may be used. Of these, thermoplastic resins are preferable. The kind of the thermoplastic resin is arbitrary and both amorphous resins and crystalline resins may be applicable. For example, synthetic fibers such as polyester fibers, polypropylene, polyamide resins, polymethyl methacrylate, polycarbonate, amorphous polyolefins, polyetherimide, polyethylene terephthalate, crystalline polymers, ABS resins, polyamide imide, polyphthalamide, polyphenylene sulfide, biodegradable plastics such as polylactic acid, and nylon resins, and composite materials thereof may be used. In addition, resin materials kneaded with various inorganic fillers such as a glass fiber, a carbon fiber, nanocarbon, and a mineral may also be used.

The polymer member in which the catalyst component is dispersed may be formed by bringing the resin molded article into contact with the pressurized fluid or may be formed by bringing the molten resin prior to molding into contact with the pressurized fluid. That is, the article to be plated upon dispersing the catalyst component therein may be a molded article having the final shape or a molten resin before being molded into a predetermined shape. Alternatively, it may be an intermediate product such as a sheet, which will be processed later. When the resin molded article is used, its shape is not particularly limited, and the article may have any shape such as a thick plate shape, a pellet shape, a tube shape, or a thin sheet shape. For example, the production method of this embodiment can be utilized in production of light reflectors such as reflectors in vehicle headlamp units, which have hitherto been produced utilizing a deposition plating method; fθ mirrors, which are used for light-scanning in laser beam printers or copy machines; or large-sized mirrors used for bending an optical path in projection televisions. When the sheet-like resin molded article is used, the thickness thereof is not particularly limited, and it is preferably from 10 to 200 μm. When the thickness is 10 μm or more, mechanical strength can be secured. On the other hand, when the thickness is 200 μm or less, floating of the sheet-like resin molded article from the mold can be prevented when a film-inserting molding method is utilized.

In the dispersing step, the method for forming the polymer member in which the catalyst component is dispersed is not particularly limited as long as the catalyst component can be dispersed in the polymer member. When dispersing the catalyst component in the resin molded article, the polymer member in which the catalyst component is dispersed can be obtained by, for example, placing the resin molded article in a highly pressure resistant hermetic container, supplying the pressurized fluid in which the catalyst component is dissolved in pressurized carbon dioxide to the hermetic container, and bringing the resin molded article into contact with the pressurized fluid. When the catalyst component is dispersed in the sheet-like resin molded article, a wound body in which the sheet-like resin molded article is wound around a separator formed from an inorganic substance may be placed in the high pressure container. Specific examples of the separator formed from an inorganic substance include mesh-sheets made of aluminum, mesh-sheets made of SUS, and glass cloths. As the pressurized fluid can pass through the separator, the pressurized fluid having high diffusibility diffuses uniformly on the whole surface of the sheet-like resin molded article and permeates into the article through the separator. As a result, damages to the resulting polymer member can be decreased and the catalyst component can be dispersed in the polymer member in the state where there is little aggregation.

When the catalyst component is dispersed in the molten resin to form a polymer member in which the catalyst component is dispersed, a polymer member in which the catalyst component is dispersed can be obtained by, for example, bringing the pressurized fluid in which the catalyst component is dissolved in pressurized carbon dioxide into contact with the molten resin within a production apparatus, dispersing the catalyst component in the molten resin, and injection-molding or extrusion-molding the resulting molten resin into a desired shape. By utilizing the injection-molding method or extrusion-molding method, the catalyst component can be dispersed directly in the molten resin and accordingly, a polymer member in which the catalyst component is dispersed can be formed at the same time with the molding of the resin. In particular, when the catalyst component is dispersed in the molten resin by utilizing the injection-molding method or the extrusion-molding method as described above, the catalyst component permeates into deep inside of the polymer member due to its own weight and the concentration of the catalyst component near the surface of the polymer member becomes low. When the pressurized fluid containing a low concentration of catalyst component is used, therefore, the concentration of the catalyst component near the surface further decreases. For this reason, according to the conventional electroless plating, a plated film having excellent adhesion cannot be formed. According to the production method of this embodiment, however, even if the catalyst component is dispersed in the molten resin at a low concentration, the plated film having excellent adhesion can be formed by combining the pretreatment step to be described later with the electroless plating step.

When the catalyst component is dispersed in the molten resin utilizing the injection-molding method or the extrusion-molding method described above, the pressurized fluid may be brought into contact with the molten resin within a plasticizing cylinder, or within a mold or an extrusion die. Further, when the injection-molding method is utilized, a so-called sandwich molding method may be used in order to form a molded article having a skin layer and a core part. Specifically, a first molten resin in which the catalyst component is dispersed is injected into a mold as described above, and a second molten resin containing no catalyst component is injected into the mold containing the first molten resin, whereby a polymer member having a skin layer and a core part may be formed. According to this molding method, a polymer member in which the catalyst component is dispersed in the surface skin layer at a concentration higher than that of the catalyst component dispersed in the core part located inside can be produced. As the first resin and the second resin, the same kind of resin may be used, but by using a resin different from the first resin as the second resin, the polymer member can be made stronger and lighter. As the first and second resins, the thermoplastic resins described above may be used.

A polymer member in which the catalyst component is dispersed can be formed by the dispersing step described above. When a polymer member having a metal reflection film is formed in this embodiment, insert molding may be further performed in which a sheet-like polymer member in which the catalyst component is dispersed is placed in a mold and a molten resin is injected into the mold, thereby integrating the sheet-like polymer member with the molten resin. With this step, the sheet-like polymer member can be integrated with the molten resin, and a partially highly-functionalized polymer member can be formed. When the sheet-like polymer member is placed in a mold, the sheet-like polymer member may be previously preformed so that the shape thereof fits the internal shape of the mold, or the sheet-like polymer member may be stuck to the mold prior to injection of the molten resin to be insert-molded.

Next, a pretreatment step of immersing the polymer member in which the catalyst component is dispersed as described above in an alcohol treatment liquid under ordinary pressure is performed. By using the pretreatment step and an electroless plating step using an electroless plating solution containing an alcohol to be described later, even if the polymer member in which the catalyst component is dispersed at a low concentration is subjected to the electroless plating under ordinary pressure, a plated film having excellent adhesion can be formed. The reason for this is not necessarily clear so far. According to the study by the present inventors, however, it can be considered that when the polymer member in which the catalyst component is dispersed is subjected to the pretreatment with the alcohol treatment liquid, the alcohol permeates into the inside of the polymer member, a portion near the surface of the polymer member swells, and the free volume of the resin component increases, whereby an effect can be obtained in which the electroless plating solution can easily permeate into the inside of the polymer member even under ordinary pressure in the subsequent electroless plating step and an effect can be obtained in which bleeding-out of the catalyst component, which is dispersed in the inside of the polymer member by the alcohol which has permeated, occurs at a portion near the surface and the concentration of the catalyst component increases at the portion near the surface. That is, it has been confirmed that when the electroless plating of immersing the polymer member in which the catalyst component is dispersed at a low concentration in the electroless plating solution containing an alcohol under ordinary pressure is performed without performing the pretreatment with the alcohol treatment liquid, no plated film is formed on the surface of the polymer member or even if a plated film is formed, only a plated film having low adhesion can be formed. It can be considered that the plated film cannot be formed because of the small amount of the plating catalyst present near the surface of the polymer member; or even if a plated film can be formed, the plated film develops using only the catalyst component present near the surface as the catalyst nucleus and therefore, it is impossible to obtain a sufficient physical anchor effect. It has also been confirmed that when a pressurized fluid containing a palladium complex is used as the catalyst component and a polymer member formed of a polyamide resin in which the catalyst component is dispersed is immersed in an alcohol treatment liquid containing 1,3-butanediol, the weight of the polymer member increases and the polymer member swells. It has further been confirmed that when a polymer member immediately after the treatment using this alcohol treatment liquid, a polymer member which has been allowed to stand at room temperature for a certain period of time after the treatment, and a polymer member which has been dried in vacuum at room temperature after the treatment to decrease the amount of the alcohol impregnated in the inside for eliminating the effect due to modification of the catalyst component are, respectively, subjected to the electroless plating using an electroless plating solution containing an alcohol at room temperature, the period of time during which the plated film develops is in the order of the polymer member which has been allowed to stand at room temperature for a certain period of time, the polymer member immediately after the treatment, and the polymer member in which the amount of the alcohol impregnated has been decreased by drying in vacuum. The reason why the development time of the plated film on the polymer member in which the amount of the alcohol impregnated has been decreased by drying in vacuum is longer than that of the plated film on the polymer member immediately after the treatment or the polymer member which has been allowed to stand at room temperature for a certain period of time can be considered that the swelling effect due to the decrease of the amount of the alcohol which has permeated into the inside of the polymer member decreases. On the other hand, when an alcohol is impregnated in the resin molded article formed of a polyamide resin, the impregnation amount of the alcohol which permeates into the inside reaches saturation in a certain period of time. Also, 1,3-butanediol hardly volatilizes at room temperature. It can be considered, accordingly, that both of the polymer member immediately after the treatment and the polymer member which has been allowed to stand at room temperature for a certain period of time are in the state where the alcohol is impregnated in the inside, and they have almost the same degree of swelling caused by the alcohol treatment liquid. Nevertheless, the reason why the difference in the development time of the plated film occurs between the two samples can be assumed that a larger amount of the catalyst component bleeds out near the surface of the polymer member by allowing the polymer member to stand, in addition to the swelling effect. It can be considered, accordingly, that the electroless plating solution can easily permeate into the polymer member having an alcohol impregnated therein due to the swelling effect in the subsequent electroless plating with the electroless plating solution containing an alcohol, and that the concentration of the catalyst component present near the surface increases due to the bleeding-out effect. As a result, it can be assumed that even if the polymer member in which a small amount of the catalyst component is dispersed is subjected to the electroless plating under ordinary pressure, a plated film having excellent adhesion can be formed.

As specific examples of the alcohol used in the alcohol treatment liquid, at least one kind selected from the group consisting of ethanol, 1-propanol, 2-propanol, 1,2-butanediol, 1,3-butane 2-methyl-2,4-pentanediol, 2-(2-butoxyethoxy)ethanol, 2-(2-ethoxyethoxy)ethanol, 2-(2-methoxyethoxy)ethanol, ethylene glycol, diethylene glycol, tetraethylene glycol, polyethylene glycol, and polypropylene glycol is preferable. Of these, alcohols which have a surface tension lower than that of water (73 dyn/cm) at 20° C. are preferable, and alcohols which have a surface tension of 50 dyn/cm or lower are more preferable in view of permeability into the polymer member. In addition, alcohols having a flash point of 40° C. or more are preferable in view of safety on production. Examples of the alcohol which has a low surface tension and a high flash point include 1,3-butanediol (surface tension: 37.8 dyn/cm, flash point: 121° C.), 2-methoxyethanol (surface tension: 31.8 dyn/cm, flash point: 43° C.), and 2-(2-methoxypropoxy)propanol (surface tension: 28.8 dyn/cm, flash point: 74° C.). Of these, 1,3-butanediol having excellent permeability is more preferable.

The alcohol treatment liquid may contain other solvents compatible with the alcohol used, such as water, as long as it contains an alcohol. Provided that when the content of the other solvents is too high, it may sometimes take a long time to develop the plated film in the electroless plating. For this reason, the content of the alcohol in the alcohol treatment liquid is preferably 50% by volume or more, more preferably 90% by volume or more. Alcohol treatment liquids which contain substantially only an alcohol except for the unavoidable impurities in the case of industrial products are particularly preferable. The alcohol treatment liquid may contain additives which serve to improve permeability into the polymer member. Specific examples of the additive include surfactants.

The pretreatment with the alcohol treatment liquid may be performed, as described above, under ordinary pressure. It is not necessary, therefore, to use an expensive production apparatus such as a highly pressure resistant container and it is possible to continuously perform the treatment. The phrase “under ordinary pressure” herein means under an atmosphere which is not pressurized. The treatment time depends on the kind of the polymer member and the kind of the alcohol and is not particularly limited, but the period of time is preferably from 1 minute to 2 hours. When the treatment time is too short, no sufficient effects of the alcohol treatment liquid can be obtained because the alcohol does not sufficiently permeate into the polymer member. On the other hand, when the treatment time is too long, production efficiency deteriorates and the resin structure of the polymer member may weaken due to the alcohol. The pretreatment with the alcohol treatment liquid may be performed at room temperature or may be performed while warming the system in order to promote the impregnation of the alcohol treatment liquid into the polymer member. When the system is warmed, the treatment temperature is preferably equal to or more than the glass transition temperature of the resin forming the polymer member although it depends on the physical properties such as the boiling point of the alcohol used. When the treatment temperature is equal to or more than the glass transition temperature of the resin forming the polymer member, the polymer member is plastically deformed and the alcohol treatment liquid can easily permeate into the polymer member.

In this embodiment, a step of providing a reducing agent in which the polymer member is treated with a reductive aqueous solution containing a reducing agent may be further provided after the pretreatment step described above and prior to the electroless plating step. By performing this step, the reducing agent can permeate into the inside of the polymer member and metal ions in the electroless plating solution can be more smoothly reduced in the subsequent electroless plating step. The reductive aqueous solution may contain an alcohol in order to improve the permeability into the polymer member. However, when the amount of the alcohol contained is too high, the solubility of the reducing agent decreases. For this reason, it is preferred that the content of the alcohol is less than 50% by volume. The same reducing agents as used in the electroless plating solution may be used as the reducing agent. Specifically, for example, at least one kind selected from the group consisting of hypophosphorous acid, sodium hypophosphite, dimethylamine borane, hydrazine, formaldehyde, sodium borohydride and phenols may be exemplified. In particular, when a nickel-phosphorus plated film is formed, at least one reducing agent selected from the group consisting of hypophosphorous acid and sodium hypophosphite is desirable.

Next, an electroless plating step is performed in which the polymer member, which has been subjected to the pretreatment with the alcohol treatment liquid as described above, is immersed in an electroless plating solution containing an alcohol under ordinary pressure to form a plated film on the polymer member. According to the production method of this embodiment, a plated film having a good anchor effect can be formed because the polymer member in which the catalyst component is dispersed has been treated with the alcohol treatment liquid in advance in the pretreatment step described above. Also, because the surface tension of the electroless plating solution is decreased by adding an alcohol to the electroless plating solution, even if the electroless plating is performed under ordinary pressure, the electroless plating solution can permeate smoothly into the polymer member. Further, because the alcohol acts as a reducing agent which slows down the development of the plated film, it can slow clown the plating reaction on the outermost surface at the time when the electroless plating solution starts to permeate into the surface portion of the polymer member. As a result, the electroless-plated film formed by this production method develops in the inside of the surface of the polymer member and the film has high adhesion strength.

The electroless plating step can be performed, as described above, under ordinary pressure. When using a conventional bath in which pressurized carbon dioxide and an electroless plating solution are forced to compatibilize by mechanically stirring them, it is difficult to stably prepare a uniform plating bath because of the pressure and temperature changes. For this reason, when multiple polymer members are subjected to the electroless plating, variation in the plating reaction easily occurs on the surface portions of the polymer members. As a result, large variation also easily occurs in the adhesion strength of the plated film. For this reason, there are problems that the adhesion of the plated film easily decreases in a heat cycle test and defects such as peeling-off or swelling easily generate in a part of the plated film, for example. On the contrary, according to the production method of this embodiment, because the electroless plating solution can be prepared under ordinary pressure, variation in the plating reaction can be inhibited and therefore, a plated film having small variation in the adhesion can be formed.

Moreover, because the polymer member is immersed in the electroless plating solution under ordinary pressure, the electroless plating can be performed, for example, by placing the electroless plating solution containing an alcohol in an open container and filling the polymer member into the open container. It is not necessary, therefore, to use the highly pressure resistant hermetic container as in a conventional case where pressurized carbon dioxide is used, and thus the electroless plating can be performed continuously. That is, the production method of this embodiment is suitable for a continuous production process.

The same alcohols as used in the pretreatment described above may be used as the alcohol to be mixed with the electroless plating solution. Of these, 1,3-butanediol having a low surface tension and a high flash point is preferable. The content of the alcohol in the electroless plating solution is arbitrary and the appropriate content is not particularly limited because it varies depending on the kind of the alcohol used. However, it is desirably from 20 to 60% by volume.

Conventionally known plating solutions may be used as the plating solution for the electroless plating solution. Specifically, examples thereof include a nickel-phosphorus plating solution, a nickel-boron plating solution, a palladium plating solution, a copper plating solution, a silver plating solution, and a cobalt plating solution. After performing the electroless plating with the electroless plating solution containing an alcohol, an electroless-plated film or an electrolytic plated film may be laminated on the electroless-plated film by using a conventional aqueous electroless plating solution. The treatment temperature in the electroless plating step is not particularly limited as long as it is equal to or more than the temperature at which the plating reaction occurs. In order to promote the permeation of the electroless plating solution, a temperature equal to or more than the glass transition temperature of the resin forming the polymer member is preferable.

The present invention is described in more detail by means of examples below, but the invention is not limited to these examples.

### Examples

### Example 1

In this example, a method is described, in which a plated film is formed by using a pressurized fluid in which a catalyst component and a fluorine organic solvent are dissolved in pressurized carbon dioxide on a polymer member in which a catalyst component formed according to a sandwich molding method is dispersed. Also, in this example, polyamide 66, which is a crystalline thermoplastic resin, (3010 R manufactured by Mitsubishi Engineering-Plastics Corporation) was used as the resin forming both of a skin layer and a core part. Further, a hexafluoroacetyl acetonatopalladium (II) complex was used as the catalyst component, and perfluorotripentylamine (manufactured by SynQuest Laboratories Inc.; molecular formula: C15F33N, molecular weight: 821.1, boiling point: 220° C.) was used as the fluorine organic solvent.

### (Dispersing Step)

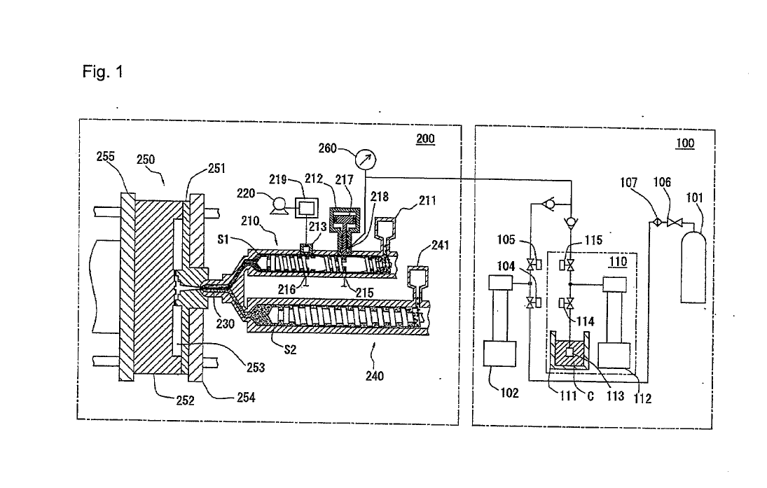

FIG. 1 is a schematic cross-sectional view showing a production apparatus used for forming a polymer member in which a catalyst component is dispersed in this example. As shown in FIG. 1, this production apparatus is provided with a pressurized fluid supply section 100 for supplying a pressurized fluid in which a catalyst component and a fluorine organic solvent are dissolved in pressurized carbon dioxide to a first plasticizing cylinder 210; the first plasticizing cylinder 210 for forming a skin layer; a second plasticizing cylinder 240 for forming a core part; and an injection-molding section 200 having a mold part 250. The operations of the pressurized fluid supply section 100 and the injection-molding section 200 are controlled through a control system (not shown).

The pressurized fluid supply section 100 has a liquid carbon dioxide cylinder 101; a syringe pump 102 for carbon dioxide, which is used for supplying pressurized carbon dioxide obtained by pressurizing liquid carbon dioxide to a predetermined pressure; and a solution preparation part 110 for preparing and supplying a mixed solution C in which a catalyst component is dissolved in a fluorine organic solvent. A pipe which connects the liquid carbon dioxide cylinder 101 to the syringe pump 102 for carbon dioxide and a pipe which connects the syringe pump 102 for carbon dioxide to the solution preparation part 110 are, respectively, provided with an air operated valve 104 for suction and an air operated valve 105 for supply. Also, the syringe pump 102 for carbon dioxide is provided with a chiller (not shown), whereby pressurized carbon dioxide is temperature-controlled to a predetermined temperature. The solution preparation part 110 is provided with a mixing chamber 111 for dissolving the catalyst component in the fluorine organic solvent to prepare a mixed solution C; and a syringe pump 112 for solution for applying a predetermined pressure to the mixed solution C and sending the solution. A pipe which connects the mixing chamber 111 to the syringe pump 112 for solution and a pipe which connects the syringe pump 112 for solution to the first plasticizing cylinder 210 are, respectively, provided with an air operated valve 114 for suction and an air operated valve 115 for supply. In this example, a mixed solution having a concentration of the catalyst component of 1.0% by mass was prepared.

When preparing a pressurized fluid, first, a catalyst component and a fluorine organic solvent are mixed and stirred at room temperature under ordinary pressure in the mixing chamber 111 to prepare a mixed solution C. Next, the air operated valve 114 for suction, which is placed on the side of the syringe pump 112 for solution, is opened, the mixed solution C is suctioned from the mixing chamber 111 through a filter 113 at room temperature, and the mixed solution C is pressurized to a predetermined pressured by pressure control of the syringe pump 112 for solution. In this example, the mixed solution C was pressurized to 10 MPa. On the other hand, liquid carbon dioxide is suctioned from the liquid carbon dioxide cylinder 101 through a filter 107 while a manual valve 106 is open, and the liquid carbon dioxide is pressurized to a predetermined pressure by pressure control of the syringe pump 102 for carbon dioxide. In this example, liquid carbon dioxide having a pressure of 4 to 6 MPa was suctioned from the liquid carbon dioxide cylinder 101 and was pressurized by using the syringe pump 102 for carbon dioxide, thereby supplying pressurized carbon dioxide having a pressure of 10 MPa and a temperature of 10° C. Pressurized carbon dioxide can be stably supplied by measuring liquid carbon dioxide having a high density at a low temperature.

When the pressurized fluid is supplied into the first plasticizing cylinder 210, after the air operated valves 104 and 114 for suction are closed and the air operated valves 105 and 115 for supply are opened, the syringe pump 102 for carbon dioxide and the syringe pump 112 for solution are switched from pressure control to flow control, and driving speeds (flow rates) and driving times of the cylinders of the syringe pump 102 for carbon dioxide and the syringe pump 112 for solution are controlled, thereby making the pressurized mixed solution C and pressurized carbon dioxide flow at a predetermined flow ratio. In this manner, the mixed solution C is mixed with pressurized carbon dioxide in the pipe. In this example, the flow ratio of the mixed solution C and pressurized carbon dioxide was set at 110. While the pressurized fluid in which the components are mixed at a predetermined flow ratio is flowed as described above, a fluid supply inlet 218 of an introduction valve 212 to be described later is opened according to a trigger signal from the mold part 250, thereby supplying a fixed amount of the pressurized fluid to the first plasticizing cylinder 210. After the pressurized fluid is supplied by the flow control, the syringe pump 102 for carbon dioxide and the syringe pump 112 for solution are stopped once, and the air operated valves 105 and 115 for supply are closed. Next, the syringe pump 102 for carbon dioxide and the syringe pump 112 for solution are switched again from flow control to pressure control, and in the same manner as above, liquid carbon dioxide and the mixed solution C are, respectively, suctioned from the liquid carbon dioxide cylinder 101 and the mixing chamber 111 and pressurized, and the system is made to wait. Further, the pressurized fluid is supplied by the flow control described above, according to the trigger signal from the mold part 250. By repeating these operations, the pressurized fluid is supplied intermittently to the first plasticizing cylinder 210. In this example, the pressurized fluid was supplied intermittently to the first plasticizing cylinder 210 at a pressure within a range of 8 to 10 MPa as measured with a pressure gauge 260 during the period from opening of the fluid supply inlet 218 of the introduction valve 212 to completion of the supply. Also, in this example, the supply amount of the pressurized fluid was controlled so that the amount of the catalyst component dispersed in the polymer member to be injection-molded is 100 ppm. Accordingly, because the pressurized fluid in this example contains the catalyst component at a low concentration, even if the pressure in the plasticizing cylinder 210 is changed, deposition of the catalyst component from the pressurized fluid can be prevented and a polymer member in which the catalyst component is uniformly dispersed can be formed. The amount of the catalyst component was found by calculating the consumption amount of the pressurized fluid in which the metal complex is dissolved per shot from the consumption amount of the high-pressure mixed solution in the syringe pump 112 for solution and converting the resulting value into the consumption amount of the metal complex per shot.

The first plasticizing cylinder 210 is provided on its upper side surface with a hopper 211 for supplying first resin, which is used for supplying a first resin to the first plasticizing cylinder 210; an introduction valve 212 for supplying the pressurized fluid; and a vent port 213 for discharging pressurized carbon dioxide from the first plasticizing cylinder 210, in this order from the upstream side. The first plasticizing cylinder 210 is also provided on its lower side surface at a position facing the introduction valve 212 and a position facing the vent port 213, with pressure gauges 215 and 216 for detecting the internal pressure, respectively, and a temperature sensor (not shown). This introduction valve 212 has a fluid supply inlet 218 on its proximal part which is coupled to the first plasticizing cylinder 210, and also has an introduction piston 217 therein. When the fluid supply inlet 218 is opened by the introduction piston 217, the pressurized fluid is supplied from the pressurized fluid supply section 100 to the first plasticizing cylinder 210. The vent port 213 is connected to a vacuum pump 220 via a buffer container 219 through discharge pipes, and when the vent port 213 is opened and the vacuum pump 220 is actuated, the inside pressure of the first plasticizing cylinder 210 is reduced. In this first plasticizing cylinder 210, accordingly, the pressurized fluid and the first molten resin are brought into contact with each other and kneaded in a pressurized state by the pressurized fluid having a high pressure between the part near the introduction valve 212 and the part near the vent port 213. The second plasticizing cylinder 240 is provided on its upper side surface with a hopper 241 for supplying second resin, which is used for supplying a second resin to the second plasticizing cylinder 240.

Driving-side ends of first and second screws S1 and S2 are coupled to motors (not shown), respectively. The resins supplied from the hoppers 211 and 241 for supplying resin are kneaded and molten in the screws S1 and S2 by heating the plasticizing cylinders 210 and 240 with band heaters (not shown) mounted on the outer wall surfaces of the plasticizing cylinders 210 and 240. Also, injection-side ends of the first and second plasticizing cylinders 210 and 240 are connected to a nozzle part 230 which communicates with a cavity 253 in the mold part 250. The tip of the nozzle part 230 is closed while kneading and therefore, the first and second molten resins are respectively extruded forward the first and second screws S1 and S2, whereby the first and second screws S1 and S2 retreat. This causes measurement to be initiated. After the resins are plasticized and measured, the first molten resin in which the catalyst component is dispersed and the second molten resin containing no catalyst component are injected from the nozzle part 230 and fill the cavity 253 by advancing the screws S1 and S2 in the plasticizing cylinders 210 and 240, respectively, using back pressure. In this example, the resins were dispersed at a temperature within a range of 220 to 240° C. of the plasticizing cylinders 210 and 240, measured by the temperature sensor. When dispersing a catalyst component in a molten resin, it is preferable that the dispersing step is performed under a high temperature atmosphere, as described above.

As shown in FIG. 1, the mold part 250 is provided with a fixed mold 251 and a movable mold 252, and the cavity 253 having a predetermined shape is formed in the mold part 250 by abutment of the fixed mold 251 to the movable mold 252. As described above, the cavity 253 is communicated with the nozzle part 230 and the first molten resin in which the catalyst component is dispersed and the second molten resin containing no catalyst component are injected from the nozzle part 230 and fill the cavity 253. The fixed mold 251 and the movable mold 252 are fixed on a fixed platen 254 and a movable platen 255, respectively, and the mold part 250 is opened or closed by driving the movable platen 255 through a damping mechanism. In this example, a mold part 250 capable of forming two disk molded articles at the same time was used. When forming the skin layer, the first molten resin, which has been plasticized and measured, is injected from the first plasticizing cylinder 210 and fill the cavity 253. At this time, the amount of the resin to be injected and filled is controlled to the extent that the inside of the cavity 253 is not entirely filled with the first molten resin.

On the other hand, the second resin is supplied from the second hopper 241 for supplying second resin into the second plasticizing cylinder 240 and plasticized and measured through the second screw S2 while the injection and filling are performed through the first plasticizing cylinder 210. At this time, the second resin in which no catalyst component is dispersed is molten in the second plasticizing cylinder 240. The plasticization and measurement of the second molten resin are completed immediately before the injection and filling of the first molten resin in which the catalyst component is dispersed are completed.

Next, after the injection and filling of the first molten resin in which the catalyst component is dispersed are completed, the second screw S2 is advanced, whereby the second molten resin containing no catalyst component is injected into and fill the cavity 253. At this time, the first molten resin in which the catalyst component is dispersed, which has been previously filled in the cavity 253, is forced onto the mold surface defining the cavity 253 by the fill pressure of the second molten resin. As a result, after the injection of the second molten resin is completed, a layer formed of the first resin in which the catalyst component is dispersed is formed as a skin layer of the polymer member, and a layer formed of the second molten resin containing no catalyst component is formed as a core part of the molded article. After the completion of the injection and filling, the mold part 250 is cooled to solidify the resin inside the mold, and a polymer member in which the catalyst component is dispersed can be obtained by opening the mold part 250.

### (Pretreatment Step)

Next, the polymer member in which the catalyst component is dispersed, which is formed as described above, is subjected to the pretreatment in which it is immersed in an alcohol treatment liquid. In this example, treatment liquids (a) to (h) shown in Table 1 below were used. For comparison, water alone was used as the treatment liquid (h). A pretreatment was performed in which each treatment liquid was added to an open container and the polymer member was immersed therein at a temperature shown in Table 1 under ordinary pressure for 30 minutes. The treatment temperature was varied for each treatment liquid because the treatment liquids have different boiling points and flash points.

TABLE 1

| | | Treatment |
|---|---|---|
| Treatment | | temperature |
| liquid | Kind | (° C.) |
| (a) | 1,3-butanediol | 100 |
| (b) | ethylene glycol | 100 |
| (c) | polyethylene glycol 200 | 120 |
| (d) | 2-methyl-2,4-pentanediol | 100 |
| (e) | mixed treatment liquid of 1,3-butanediol and | 100 |
| | polyethylene glycol 200 (volume ratio: 1/1) | |
| (f) | mixed treatment liquid of 1,3-butanediol and | 90 |
| | water (volume ratio: 1/1) | |
| (g) | mixed treatment liquid of polyethylene glycol | 90 |
| | 200 and water (volume ratio: 1/1) | |
| (h) | water | 90 |

### (Electroless Plating Step)

Next, the polymer member which has been subjected to the pretreatment as described above was subjected to electroless plating in which the polymer member was immersed in an electroless plating solution containing an alcohol under ordinary pressure. In this example, an electroless plating solution (alcohol content in the electroless plating solution: 50% by volume) was used, the solution being prepared by mixing 1,3-butanediol with a nickel-phosphorus plating solution containing a metal salt of nickel sulfate, a reducing agent, and a complexing agent (Nicoron DK manufactured by Okuno Chemical Industries Co., Ltd.). The electroless plating solution was added to an open container and the polymer member was immersed therein, whereby the electroless plating was performed at a temperature of 70 to 90° C. under ordinary pressure (samples 1 to 8). For comparison, similarly, a polymer member, which was not subjected to pretreatment, was subjected to the electroless plating by using an electroless plating solution containing an alcohol (sample 9); and a polymer member subjected to the pretreatment by using the treatment liquid (a) [1,3-butanediol] was subjected to the electroless plating by using an aqueous electroless plating solution containing no alcohol (an electroless plating solution in which the alcohol in the electroless plating solution containing the alcohol used above was substituted by water) (sample 10). Development times (the period of time until deposition starts and the period of time until the whole surface was covered with the film) and surface quality of the plated film of each sample were evaluated after performing the electroless plating as described above. The surface quality was evaluated as follows: when the plated film was visually observed, a case where the plated film having no defect was formed on the whole surface and there was no problem in the appearance is marked with “good”; a case where the plated film was formed on the whole surface but peeling-off or swelling partly occurred is marked with “acceptable”; and a case where the plated film was not formed partly or completely is marked with “poor”.

Next, a plated film was laminated on the plated film of the sample having the formed plated film by using an aqueous electroless plating solution containing no alcohol, and adhesion and change in the adhesion of the plated film in a heat cycle test were evaluated. The results are shown in Table 2.

### [Adhesion]

In accordance with JIS H 8630, a force applied when the plated film was peeled off from the polymer member was measured by using a tensile tester (AGS-100N manufactured by Shimadzu Corporation) under conditions of an angle of 90° and a speed of 25 mm/min at a distance of 45 mm.

### [Heat Cycle Test]

A test in which the temperature was changed between −40° C. and 100° C. was repeated 50 cycles. After the test was completed, the plated film was visually observed. The following evaluations were made: a case where there was no problem in the appearance is marked with “good”; a case where peeling-off or swelling occurred on a part of the plated film is marked with “acceptable”; and a case where peeling-off or swelling occurred on the whole surface of the plated film is marked with “poor”.

TABLE 2

| | | | Electroless plating | | | | | |
|---|---|---|---|---|---|---|---|---|
| | | | | Development | | | | |
| | | | | time of | | | | |
| | | | | plated film | | | | |
| | | | | | Time | | | |
| | | | | | until | | | |
| | | | | | whole | | | |
| | Pretreatment | | | | surface | | | |
| | | Treatment | Alcohol | Start of | was | Surface | Adhesion | Heat cycle |
| Sample | Presence/absence | liquid | presence/absence | deposition | covered | quality | (N/cm) | test |
| 1 | present | (a) | present | 40 seconds | 3 minutes | good | 28.9 | good |
| 2 | present | (b) | present | 40 seconds | 7.5 minutes | good | 15.3 | good |
| 3 | present | (c) | present | 1 minute | 9 minutes | good | 8.5 | good |
| 4 | present | (d) | present | 1.5 minutes | 6 minutes | good | 26.0 | good |
| 5 | present | (e) | present | 50 seconds | 6 minutes | good | 16.5 | good |
| 6 | present | (f) | present | 1.5 minutes | 10 minutes | good | 6.3 | good |
| 7 | present | (g) | present | 2 minutes | 15 minutes | good | 3.9 | acceptable |
| 8 | present | (h) | present | 15 minutes | Not whole | poor | — | poor |
| | | | | | surface | | | |
| | | | | | was | | | |
| | | | | | covered | | | |
| 9 | absent | — | present | 10 minutes | Not whole | poor | — | poor |
| | | | | | surface | | | |
| | | | | | was | | | |
| | | | | | covered | | | |
| 10 | present | (a) | absent | no | no | poor | — | — |
| | | | | deposition | deposition | | | |

As shown in the above table, it is understood that an electroless-plated film can be formed on the whole surface of even the polymer member in which the catalyst component is dispersed at a low concentration under ordinary pressure in a short time by combining the pretreatment with the alcohol treatment liquid with the electroless plating with the electroless plating solution containing an alcohol. It is also understood that the plated film produced according to this production method has high adhesion and few peeling-off or swelling of the plated film in the heat cycle test, and accordingly a plated film having excellent adhesion can be formed. It is further understood that the plated film having higher adhesion can be formed by subjecting the polymer member to the pretreatment with the alcohol treatment liquid containing a small amount of water.

On the contrary, with respect to the sample which was not subjected to the pretreatment with the alcohol treatment liquid and the sample which was subjected to the pretreatment with the treatment liquid containing water alone, the deposition of the plated film took a long time or the plated film was not formed on the whole surface. It is also understood that even if the pretreatment with the alcohol treatment liquid is performed, the plated film is not formed on the sample which was not subjected to the electroless plating with the electroless plating solution containing an alcohol. As a result, the adhesion and the heat cycle test of this sample could not be measured.

### Example 2

In this example, a method is described in which a pressurized fluid in which a catalyst component is dissolved in pressurized carbon dioxide is brought into contact with a sheet-like resin molded article in a batch manner, thereby forming a sheet-like polymer member in which the catalyst component is dispersed; the sheet-like polymer member is subjected to a pre-forming method to be formed into a predetermined shape; the molded, sheet-like polymer member is placed in a mold; the sheet-like polymer member is integrated with a molten resin by a film insert molding method; and the integrated polymer member is subjected to electroless plating, thereby forming a plated film thereon. In this example, a nylon 6 sheet (Novamid 1020 manufactured by Mitsubishi Engineering-Plastics Corporation, thickness: 200 μm), and the hexafluoroacetyl acetonatopalladium (II) complex same as in Example 1 were used as the sheet-like resin article and the catalyst component, respectively. As the resin to be integrated by the film insert molding, a polyphthal amide resin (AMODEL AS-1566 manufactured by Solvay Advanced Polymers K.K.) was used.

### (Dispersing Step)

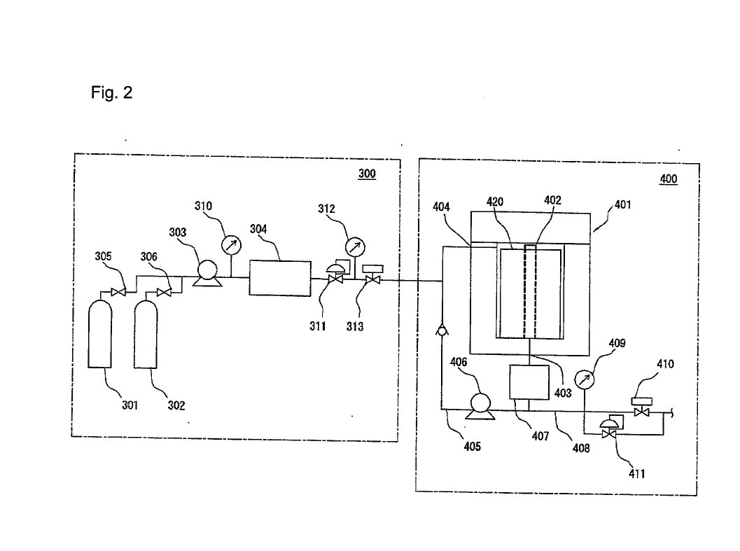

FIG. 2 is a schematic view showing a production apparatus used for forming a sheet-like polymer member in which a catalyst component is dispersed in this example. As shown in FIG. 2, the production apparatus is provided with a fluid supply section 300 for supplying pressurized carbon dioxide; and a high-pressure treatment section 400 in which the pressurized fluid is brought into contact with the sheet-like resin molded article and the catalyst component is dispersed in the sheet-like resin molded article.

The fluid supply section 300 is provided with two liquid carbon dioxide cylinders 301 and 302; a pump 303 which pressurizes liquid carbon dioxide to a predetermined pressure and supplies pressurized carbon dioxide; and a buffer container 304. A pipe which connects the liquid carbon dioxide cylinders 301 and 302 to the pump 303 is provided with a pressure gauge 310, and a pipe which connects the buffer container 304 to the high-pressure treatment section 400 is provided with a decompression valve 311, a pressure gauge 312 and an automatic valve 313 in this order from the upstream side.

When pressurized carbon dioxide is supplied into the high-pressure treatment section 400, manual valves 305 and 306 for the liquid carbon dioxide cylinders 301 and 302 are opened, liquid carbon dioxide is passed through the temperature-controlled pipe to gasify, and then the pressure of carbon dioxide is increased through the pump 303 so that the pressure detected by the pressure gauge 310 reaches a predetermined pressure. In this manner, pressurized carbon dioxide having the predetermined pressure is supplied into the buffer container 304. Pressurized carbon dioxide supplied into the buffer container 304 is temperature-controlled to a predetermined temperature and then the pressure thereof is decreased through the decompression valve 311 so that the pressure reaches a predetermined pressure. By opening the automatic valve 313, pressurized carbon dioxide is supplied into the high-pressure treatment section 400. In this example, liquid carbon dioxide having a pressure of 4 to 6 MPa was suctioned from the liquid carbon dioxide cylinders 301 and 302 and gasified through a pipe whose temperature was controlled to 10° C., and then the pressure of the resulting gas was increased to 15 MPa through the pump 303, and the gas was supplied into the buffer container 304 whose temperature was controlled to 50° C. Thereafter, pressurized carbon dioxide was depressurized through the decompression valve 311 so that the pressure detected by the pressure gauge 312 became 10 MPa, and then pressurized carbon dioxide was supplied into the high-pressure treatment section 400.

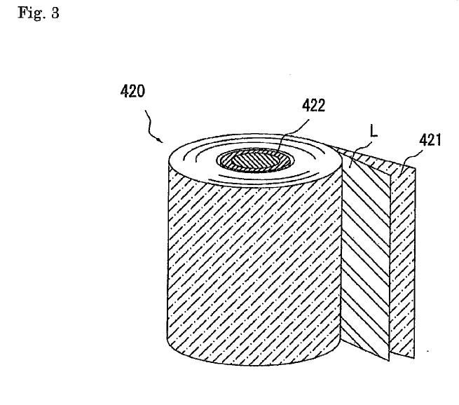

The high-pressure treatment section 400 is provided with a high pressure container 401 for bringing the sheet-like resin molded article into contact, with the pressurized fluid, and, as shown in FIGS. 2 and 3, in the high pressure container 401, a wound body 420 is contained in which a sheet-like resin molded article L is wound around a cylindrical body 422 having a number of through-holes via a mesh-separator 421. This wound body 420 is inserted into a cylindrical supporting member 402 having a number of through-holes, which is placed at the center of the high pressure container 401. As shown in FIG. 2, a fluid supply inlet 403 is provided in the lower part of the high pressure container 401 and a fluid outlet 404 is provided in the upper part of the high pressure container 401. The fluid supply inlet 403 and the fluid outlet 404 are connected via a circulation conduit 405 so that the pressurized fluid circulates within the high pressure container 401. A circulating pump 406 for circulating the pressurized fluid within the circulation conduit 405 and a dissolution bath 407 in which the catalyst component is contained are placed between a connecting portion where the circulation conduit 405 is connected to the fluid supply section 300, and the fluid supply inlet 403. The circulation conduit 405 which connects the circulating pump 406 to the dissolution bath 407 is connected to a discharge conduit 408, and the discharge conduit 408 is provided with a pressure gauge 409, an automatic valve 410, and a back-pressure regulating valve 411. With such a structure, when pressurized carbon dioxide is supplied from the fluid supply section 300, pressurized carbon dioxide is supplied into the dissolution bath 407 through the circulating pump 406, the catalyst component is dissolved in the dissolution bath 407, and the pressurized fluid containing the catalyst component is supplied into the high pressure container 401. At this time, the pressure of the back-pressure regulating valve 411 is set at a predetermined pressure, and when the pressure of the pressurized fluid within the circulation conduit 405 is decreased, pressurized carbon dioxide is supplemented from the automatic valve 313. On the other hand, when the pressure of the pressurized fluid within the circulation conduit 405 is higher than the predetermined pressure, the pressurized fluid is discharged from the discharge conduit 408. The pressure within the high pressure container 401 and the pressure within the circulation conduit 405 are kept constant by this mechanism. In this example, while the pressure of the back-pressure regulating valve 411 was set at 10 MPa, which is the same pressure as pressurized carbon dioxide, and the pressures within the high pressure container 401 and the circulation conduit 405 were kept at 10 MPa, the treatment was performed by circulating the pressurized fluid so that the amount of the catalyst component to be dispersed in the sheet-like resin molded article L was 10 ppm. Also, in this example, after the treatment, the temperature within the high pressure container 401 was kept at 50° C. for 30 minutes, and the temperature within the high pressure container 401 was elevated to 120° C. by using a temperature controlling machine (not shown) and kept as it was for 30 minutes. In this manner, the metal complex dispersed in the sheet-like resin molded article L was heat-reduced. The amount of the catalyst component was found by measuring the initial weight of the sheet before the dispersing step in a condition where moisture is removed from the sheet-like resin molded article by vacuum-drawing for 24 hours, measuring the weight of the sheet after the dispersing step in the same manner as above, and calculating the amount of change from the obtained values.

### (Film Insert Molding Step)

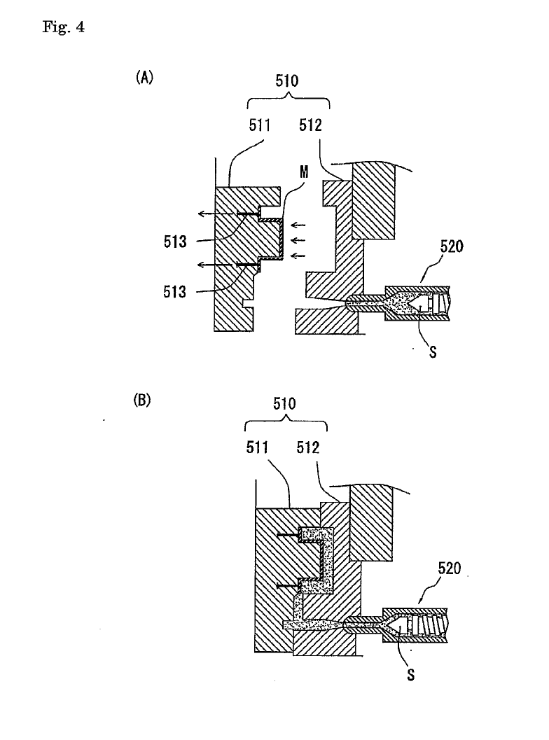

Next, in this example, using the sheet-like polymer member in which the catalyst component was dispersed as described above, insert molding in which a molten resin was integrated with the sheet was performed by a film insert molding method. Specifically, first, the sheet-like polymer member was cut into a predetermined size, and the resulting polymer member was softened by an indirect heat source using an infrared heater. Thereafter, the polymer member was overlaid on a pre-forming die shown in FIG. 4, which mimicked a mold for injection-molding, and pressurized air having a pressure of 1 MPa was blown to the polymer member, thereby making the polymer member stick to the pre-forming die, thus the shape of the die was transferred to the polymer member. The pre-formed polymer member was taken out from the pre-forming the to obtain a box-shaped polymer member.

Next, as shown in FIGS. 4A and 4B, the catalyst component was dispersed in a mold part 510 for injection-molding as described above, the pre-formed polymer member M was inserted therein, and the insert molding was performed. Specifically, first, as shown in FIG. 4A, the box-shaped polymer member M was stuck to a movable mold 511, and then the polymer member M was fixed to the movable mold 511 by vacuum suction through a groove 513 for vacuum-drawing. Thereafter, as shown in FIG. 4B, the movable mold 511 and a fixed mold 512 were abutted to each other and the molten resin within a plasticizing cylinder 520 whose temperature was arbitrary controlled was injected into and filled the mold part 510 by advancing a screw S. Then, after clamping with the mold part 510, the mold part 510 was released, whereby an insert-molded polymer member was obtained.

### (Pretreatment Step)

Next, pretreatment in which the polymer member formed as described above is immersed in an alcohol treatment liquid is performed. In this example, the treatment liquid (a) [1,3-butanediol] used in Example 1 was used as the alcohol treatment liquid and pretreatment in which the polymer member was immersed in this liquid at 100° C. for 15 minutes was performed.

### (Electroless Plating Step)

Next, electroless plating in which the polymer member subjected to pretreatment as described above is immersed in an electroless plating solution containing an alcohol under ordinary pressure is performed. In this example, the electroless plating was performed by using an electroless plating solution containing 1,3-butanediol under ordinary pressure in the same manner as in Example 1. For comparison, a polymer member which was not subjected to the pretreatment was subjected to electroless plating by using an electroless plating solution containing an alcohol (sample 12), similarly to Example 1. Further, a polymer member which had been subjected to the pretreatment was subjected to the electroless plating by using an aqueous electroless plating solution containing no alcohol (sample 13). With respect to each sample, the development time of the plated film, the surface quality, adhesion and the change in adhesion of the plated film in the heat cycle test were evaluated in the same manner as in Example 1. The results are shown in Table 3.

TABLE 3

| | | | Electroless plating | | | | | |
|---|---|---|---|---|---|---|---|---|
| | | | | Development | | | | |
| | | | | time of | | | | |
| | | | | plated film | | | | |
| | | | | | Time | | | |
| | | | | | until | | | |
| | | | | | whole | | | |
| | Pretreatment | | | | surface | | | Heat |
| | | Treatment | Alcohol | Start of | was | Surface | Adhesion | cycle |
| Sample | Presence/absence | liquid | presence/absence | deposition | covered | quality | (N/cm) | test |
| 11 | present | (a) | present | 20 seconds | 50 seconds | good | 15.5 | good |
| 12 | absent | — | present | 6 minutes | Not whole | poor | — | poor |
| | | | | | surface | | | |
| | | | | | was | | | |
| | | | | | covered | | | |
| 13 | present | (a) | absent | no | no | poor | — | — |
| | | | | deposition | deposition | | | |

As shown in the above table, it is understood that an electroless-plated film can be formed on the whole surface of even the sheet-like polymer member in which the catalyst component is dispersed at a low concentration under ordinary pressure for a short time by performing the pretreatment with the alcohol treatment liquid and the electroless plating with the electroless plating solution containing an alcohol. It is also understood that the plated film produced according to this production method has high adhesion.

On the contrary, with respect to the sample not subjected to the pretreatment with the alcohol treatment liquid and the sample subjected to the pretreatment with the alcohol treatment liquid but not subjected to the electroless plating with the electroless plating solution containing an alcohol, the plated film was not deposited at all, or even if the plated film was deposited, it took a long time until the film was deposited, and the plated film was not formed on the whole surface. For these reasons, the adhesion of these samples could not be measured. Also, the heat cycle test for the sample in which the plated film was not formed at all could not be evaluated.

As described above, according to the production method of the present invention, a plated film having excellent adhesion can be formed by combining the pretreatment using an alcohol treatment liquid under ordinary pressure with the electroless plating using an electroless plating solution containing an alcohol under ordinary pressure.

Preferable aspects of the present invention are described in the following.

(1) In an aspect in which the catalyst component is dispersed in the resin molded article, a method for producing a polymer member having a plated film is preferable, which method includes:

a dispersing step of bringing a pressurized fluid in which a catalyst component containing a metal which serves as a plating catalyst is dissolved in pressurized carbon dioxide into contact with a resin molded article to form a polymer member in which the catalyst component is dispersed;

a pretreatment step of immersing the polymer member in which the catalyst component is dispersed in an alcohol treatment liquid under ordinary pressure; and

an electroless plating step of immersing the polymer member treated with the alcohol treatment liquid in an electroless plating solution containing an alcohol under ordinary pressure to form a plated film.

(2) In the aspect described above, a sheet-like resin molded article may be used as the resin molded article.

(3) In the aspect described above, when a film insert molding method is utilized, a method for producing a polymer member having a plated film is preferable, which method includes:

a dispersing step of bringing the pressurized fluid in which the catalyst component containing the metal which serves as the plating catalyst is dissolved in pressurized carbon dioxide into contact with a sheet-like resin molded article to form a sheet-like polymer member in which the catalyst component is dispersed;

an insert molding step of placing the sheet-like polymer member in which the catalyst component is dispersed in a mold and injecting a molten resin into the mold, whereby the sheet-like polymer member and the molten resin are integrated;

a pretreatment step of treating the polymer member subjected to the insert molding with the alcohol treatment liquid under ordinary pressure; and

an electroless plating step of immersing the polymer member treated with the alcohol treatment liquid in the electroless plating solution containing the alcohol under ordinary pressure to form a plated film.

(4) In another aspect in which the catalyst component is dispersed in the molten resin, a method for producing a polymer member having a plated film is preferable, which method includes:

a dispersing step of bringing a pressurized fluid in which a catalyst component containing a metal which serves as a plating catalyst is dissolved in pressurized carbon dioxide into contact with a molten resin, and the molten resin in which the catalyst component is dispersed is injection-molded or extrusion-molded to form a polymer member in which the catalyst component is dispersed;

a pretreatment step of immersing the polymer member in which the catalyst component is dispersed in an alcohol treatment liquid under ordinary pressure; and

an electroless plating step of immersing the polymer member treated with the alcohol treatment liquid in an electroless plating solution containing an alcohol under ordinary pressure to form a plated film.

(5) In another aspect described above, the sheet-like polymer member may be molded through extrusion-molding. That is, the dispersing step may include forming a sheet-like polymer member in which the catalyst component is dispersed by bringing the pressurized fluid in which the catalyst component containing the metal which serves as the plating catalyst is dissolved in pressurized carbon dioxide with the molten resin, and extrusion-molding the molten resin in which the catalyst component is dispersed.

(6) Further, in another aspect described above, a method for producing a polymer member having a plated film is preferable, which method includes:

a dispersing step of bringing, in order to disperse the catalyst component at a higher concentration near the surface of the polymer member, the pressurized fluid in which the catalyst component containing the metal which serves as the plating catalyst is dissolved in pressurized carbon dioxide into contact with a first molten resin, injecting the first molten resin in which the catalyst component is dispersed into a mold, and injecting a second molten resin containing no catalyst component into the mold which contains the first molten resin in which the catalyst component is dispersed to form a polymer member in which the catalyst component is dispersed;

a pretreatment step of immersing the polymer member in which the catalyst component is dispersed in the alcohol treatment liquid under ordinary pressure; and

an electroless plating step of immersing the polymer member which has been subjected to the pretreatment with the alcohol treatment liquid in the electroless plating solution containing the alcohol under ordinary pressure to form a plated film.

(7) In another aspect described above, the pressurized fluid preferably contains a fluorine organic solvent.

### REFERENCE SIGNS LIST

100 Pressurized fluid supply section
200 Injection-molding section
250 Mold part
300 Fluid supply section
400 High-pressure treatment section
L Sheet-like resin molded article
M Sheet-like polymer member

What is claimed is:

1. A method for producing a polymer member having a plated film, comprising:
a dispersing step of forming, using a pressurized fluid in which a catalyst component containing a metal which serves as a plating catalyst is dissolved in pressurized carbon dioxide, a polymer member in which the catalyst component is dispersed;
a pretreatment step of immersing the polymer member in which the catalyst component is dispersed in an alcohol treatment liquid under ordinary pressure; and
an electroless plating step of immersing the polymer member subjected to the pretreatment with the alcohol treatment liquid in an electroless plating solution containing an alcohol under ordinary pressure to form a plated film.

2. The method for producing a polymer member having a plated film according to claim 1, wherein the dispersing step comprises forming a polymer member in which the catalyst component is dispersed by bringing the pressurized fluid into contact with a resin molded article.

3. The method for producing a polymer member having a plated film according to claim 2, wherein the resin molded article is a sheet-like resin molded article.

4. The method for producing a polymer member having a plated film according to claim 3, further comprising an insert molding step of placing the sheet-like polymer member in which the catalyst component is dispersed in a mold and injecting a molten resin into the mold to integrate the sheet-like polymer member with the molten resin, after the dispersing step and before the pretreatment step.

5. The method for producing a polymer member having a plated mm according to claim 1, wherein the dispersing step comprises forming the polymer member in which the catalyst component is dispersed by bringing the pressurized fluid into contact with a molten resin and injection-molding or extrusion-molding the molten resin in which the catalyst component is dispersed.

6. The method for producing a polymer member having a plated film according to claim 1, wherein the dispersing step comprises forming the polymer member in which the catalyst component is dispersed by bringing the pressurized fluid into contact with a first molten resin, injecting the first molten resin in which the catalyst component is dispersed into a mold, and injecting a second molten resin containing no catalyst component into the mold containing the first molten resin in which the catalyst component is dispersed.

7. The method for producing a polymer member having a plated film according to claim 5 or 6, wherein the pressurized fluid further contains a fluorine organic solvent.
